(19) United States
(12) Patent Application Publication
(10) Pub. No.: US 2004/0088482 A1
(43) Pub. Date: May 6, 2004

(54) Systems for storing data

(76) Inventors: Herbert J. Tanzer, Cool, CA (US); Patrick S. McGoey, Cameron Park, CA (US)

Correspondence Address: HEWLETT-PACKARD COMPANY, Intellectual Property Administration, P.O. Box 272400, Fort Collins, CO, 80527-2400, US

(21) Appl. No.: 10/287,184

(22) Filed: Nov. 4, 2002

(51) Int. Cl. G06F 12/00

(52) U.S. Cl. 711/114; 361/685

(57) ABSTRACT

Data storage systems are provided. One such data storage system includes a first data storage carrier that incorporates multiple disk drives mounted adjacent to each other. Other systems also are provided.

### BACKGROUND OF THE INVENTION

1. Field of the Invention

The present invention relates generally to data storage and, in particular, to data storage systems that provide increased data storage density.

2. Description of the Related Art

Data storage typically is accomplished in a commercial environment by using enclosures that mount multiple disk drives. Disk drives normally are mounted within data storage carriers that facilitate handling and cooling, for example, of the disk drives. Typically, each data storage carrier is configured to be mounted within a slot of such an enclosure.

A representative prior art data storage system is depicted schematically in FIG. 1. As shown in FIG. 1, data storage system 10 includes an enclosure 12 that defines an interior 14. Interior 14 is accessible via opening 16 which is sized to receive data storage carrier 10.

Data storage carrier 18 includes a single disk drive 20. The disk drive communicates with a communication connector 22 that enables the disk drive to communicate with a data bus or midplane 24 of the enclosure. Communication connector 22 facilitates communication by mating with a corresponding connector 26 of the midplane. Clearly, a relatively high degree of data storage density is provided by such a data storage system. Note, multiple enclosures, each of which mounts multiple carriers, can be mounted to a rack, thus forming a conventional rack-mounted configuration.

As advances in technology enable the size of disk drives to be reduced, legacy enclosures, such as enclosure 12 of FIG. 1, typically become obsolete. This is because the openings of the enclosures are sized to receive data storage carriers of a specific size. Thus, when a data storage carrier is reconfigured to mount a disk drive of reduced size, such a legacy enclosure may not be able to mount the reconfigured data storage carrier. Therefore, it should be understood that there is a need for improved systems and methods that address these and/or other perceived shortcomings of the prior art.

### SUMMARY OF THE INVENTION

Briefly described, the present invention involves the use of data storage carriers, each of which accommodates multiple disk drives. In this regard, an embodiment of a data storage system in accordance with the invention includes a data storage carrier that incorporates a housing and an interface. The housing defines an interior and an opening, with the opening being sized and shaped to receive multiple disk drives so that the disk drives are insertable into the interior through the opening. The interface is mounted to the housing and includes multiple second communication connectors and a third communication connector. Each of the second communication connectors is accessible via the interior of the housing and is configured to mate with a corresponding one of the first communication connectors. This enables each of the disk drives to communicate with the interface. The third communication connector is accessible via an exterior of the housing. Additionally, the interface is operative to receive data via the third connector and provide the data to the multiple disk drives via the second connectors.

Another embodiment of a data storage system in accordance with the invention includes a first data storage carrier that incorporates multiple disk drives mounted adjacent to each other. Additionally, the disk drives are addressable via a single data address using the data bus.

An embodiment of a method in accordance with the invention includes providing a carrier and mounting multiple disk drives within the carrier.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a prior art data storage system.

FIG. 2 is a schematic diagram of an embodiment of a data storage system in accordance with the present invention.

FIG. 3 is a schematic diagram of an embodiment of a data storage carrier in accordance with the present invention.

FIG. 4 is a schematic diagram of the embodiment of FIG. 3, with one of the disk drives removed.

FIG. 5 is a schematic diagram of the embodiment of FIGS. 3 and 4, showing the rear of the carrier.

FIG. 6 is a schematic diagram of another embodiment of a data storage system in accordance with the present invention.

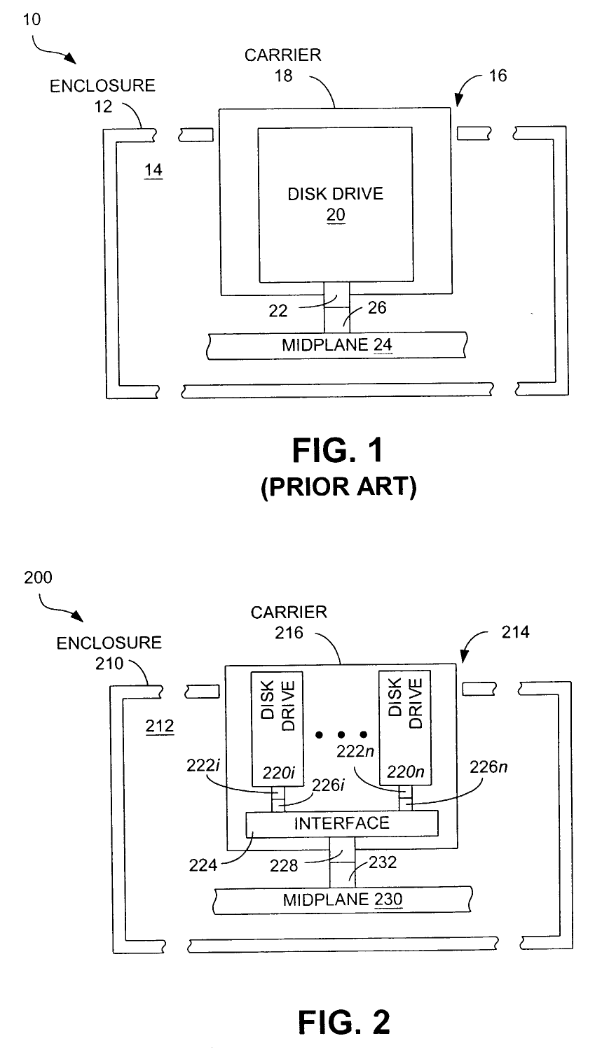

### DETAILED DESCRIPTION

As will be described in detail here, data storage systems in accordance with the invention can, for example, extend the useful life of legacy data storage enclosures that were originally designed to accommodate independently mounted disk drives. This is accomplished by providing multiple disk drives within a single data storage carrier. Since, in some embodiments, the data storage carrier is sized to be mounted to such an enclosure, providing multiple disk drives within the data storage carrier increases the data storage density of the enclosure. As should be understood, this can alleviate the need for discarding an enclosure when reduced sized disk drives become available.

Referring now to the drawings, FIG. 2 is a schematic diagram depicting an embodiment of a data storage system in accordance with the invention. As shown in FIG. 2, data storage system 200 includes an enclosure 210 that defines an interior 212. Interior 212 is accessible via opening 214 that is sized to receive data storage carrier 216. Note, only one opening and one corresponding data storage carrier are shown in FIG. 2 for ease of description, although various numbers of openings and carriers can be provided.

Data storage carrier 216 includes multiple disk drives (220i-220n). Each disk drive communicates with a communication connector (222i-222n) that enables the disk drive to communicate with an interface 224 of the data storage carrier. Each of the communication connectors 222i-222n mates with a corresponding communication connector (226i-226n) of the interface.

The interface 224 also includes a communication connector 228 that mates with a corresponding connector of the enclosure. More specifically, midplane 230 of the enclosure includes one or more communication connectors, e.g., connector 232, each of which is configured to facilitate communication of the midplane with a data storage carrier. Thus, in the embodiment of FIG. 2, connector 228 of carrier 216 mates with connector 232 of the midplane and enables the disk drives of carrier 216 to communicate with the midplane of enclosure 210.

By providing multiple disk drives within a single carrier, some inherent limitations associated with using a single disk drive-carrier configuration can be overcome. By way of example, when the disk drive is a 2.5 inch small form factor (SFF) disk drive, such a disk drive is small enough to cause difficulty during user handling. In particular, in a high-density data-storage application where the drives are located close to each other, it can be difficult for a user to grasp a designated drive, such as when the drive is to be replaced. Therefore, by arranging multiple disk drives within a carrier, an entire carrier could be removed from an enclosure when maintenance or another operation is to be performed with respect to one of the accompanying disk drives. The entire carrier then can be transported to a suitable working environment for servicing the disk drive.

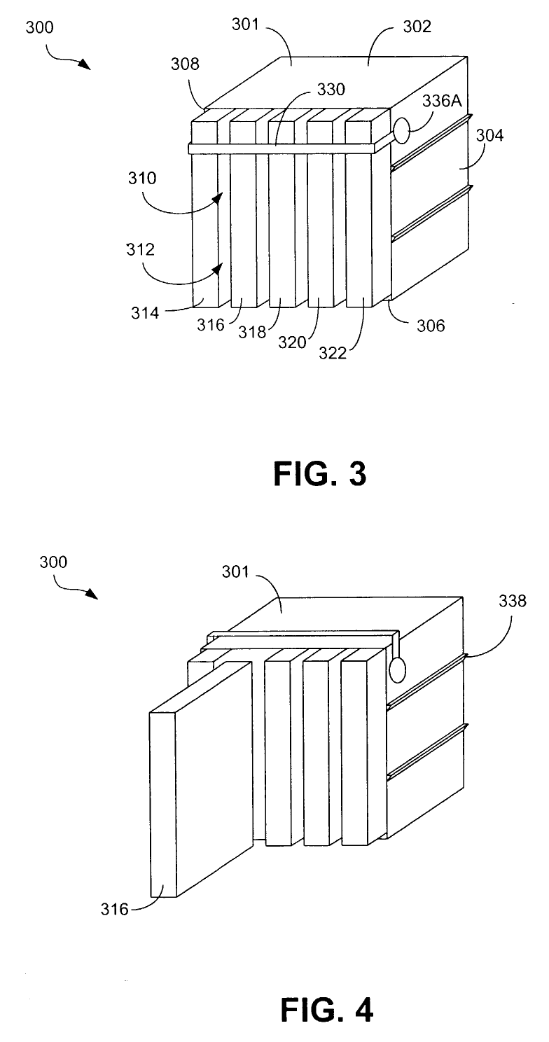

An embodiment of a data storage carrier in accordance with the invention is depicted schematically in FIG. 3. As shown in FIG. 3, carrier 300 includes a housing 301 that incorporates sidewalls 302, 304, 306 and 308. The sidewalls define an interior 310 that is used to mount multiple disk drives. Access to interior 310 is provided by an opening 312 that permits disk drives to be received by the interior. In particular, opening 312 of this embodiment is sized for receiving five disk drives, i.e., drives 314, 316, 318, 320 and 322. Clearly, various numbers of openings and configurations that permit placement of various numbers of disk drives per opening can be used.

In FIG. 3, the disk drives are depicted in mounted positions that start the disk drives in a side-by-side relationship with respect to each other. Preferably, spaces are provided between adjacent disk drives to promote cooling. In other embodiments, however, spaces between adjacent components may not be required.

The disk drives are maintained in their respective mounted positions by a retaining mechanism 330. In the embodiment of FIG. 3, the retaining mechanism is a bar that is shaped to extend across at least a portion of opening 312. The retaining mechanism prevents the disk drives from being removed from the housing when the retaining mechanism is in the closed position depicted in FIG. 3.

The retaining mechanism is depicted in an open position in FIG. 4. The open position corresponds to the retaining mechanism being located to provide clearance for one or more of the disk drives to be removed from and/or inserted into the housing. By way of example, disk drive 316 is depicted as being removed from the housing.

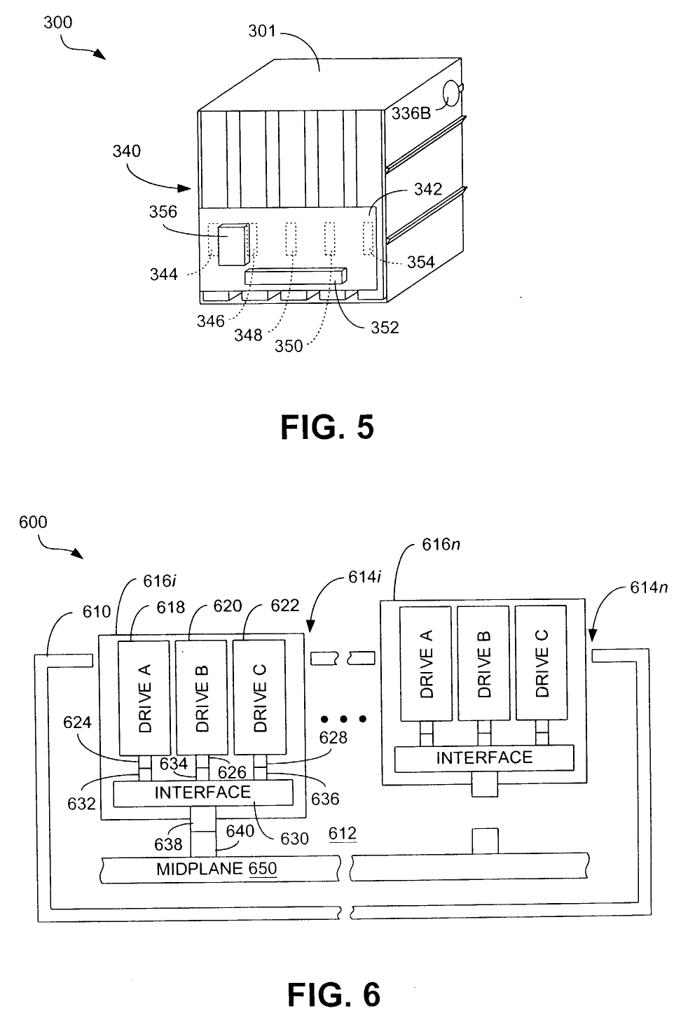

Retaining mechanism is moved between the closed position of FIG. 3 and the open position of FIG. 4 by rotating the bar of the retaining mechanism about pivots 336a and 336b (FIG. 5). Note, the retaining mechanism also can be used as a handle for transporting the carrier and/or for facilitating mounting of a carrier to and/or removal of a carrier from an enclosure (not shown). Also note that the embodiment of FIGS. 3 and 4 includes guides 338 that align the carrier within an enclosure. In particular, the guides can contact corresponding surfaces of an enclosure so that the guides slide against the surfaces to properly align the carrier during mounting. Clearly, various types and numbers of guides could be used.

As mentioned before, in a data storage enclosure that includes multiple disk drives located adjacent to each other, handling of each of the disk drives can be problematic. In particular, it can be difficult to provide a handle for removing/inserting and/or otherwise handling each of the disk drives independently. Retaining mechanism 330 alleviates this problem by providing a handle that can be used for transporting a carrier and its accompanying disk drives.

The rear 340 of data storage carrier 300 of FIGS. 3 and 4 is depicted schematically in FIG. 5. Specifically, interface 342 is displayed. Interface 342 includes communication connectors 344, 346, 348, 350 and 352 that enable the disk drives to communicate with the interface. In order to facilitate mating of the various connectors, interface 342 preferably is rigidly secured to housing 301.

Interface 342 also incorporates a connector 354 that is used to communicatively couple the carrier to an enclosure. Connector 354 preferably is hot-swappable, i.e., the connector can be disconnected from the enclosure without removing power from the carrier, although a cold-swappable configuration can be used. Typically, hot-swappable capability involves the use of one or more of staggered pin lengths of the pins of the connector and control of data interrupts.

A controller 356 is mounted to the interface and coordinates the flow of data to and/or from the disk drives. Typically, controller 356 is a processor-based device that routes data among the disk drives in a random array of independent disks (RAID) format. In such an embodiment, the interface and associated controller enable the carrier to function as a single addressable block of disk drives with data storage redundancy. Note, the controller can be used to facilitate hot-swappable connectivity by controlling data interrupts.

By treating the multiple disk drives of the carrier as a single addressable target, parallel processing of data can be used to overcome a read/write dataflow bottleneck that is typically exhibited by disk drives. By way of example, received data can be striped across the disk drives of the carrier. That is, a first portion of data received can be directed for storage at a first of the disk drives, a second portion of data can be directed for storage at a second of the disk drives, and so on, until a portion of data has been stored at each of the disk drives. Subsequent portions of data then can be saved in a similar manner. Thus, any latency exhibited by a disk drive can be overcome by intermittently providing data to or receiving data from the disk drive.

Another embodiment of a data storage system in accordance with the invention is depicted schematically in FIG. 6. As shown in FIG. 6, data storage system 600 includes an enclosure 610 that defines an interior 612. The interior 612 is accessible via openings 614i through 614n, each of which is sized to receive a data storage carrier. In particular, the openings are configured to receive carriers 616i through 616n, respectively. Note, carrier 616n is not currently mounted to the enclosure.

In FIG. 6, each of the data storage carriers includes three disk drives, e.g., drives 618, 620 and 622. Each of the disk drives includes a communication connector, e.g., connectors 624, 626 and 628, respectively, that enables the disk drive to communicate with an interface 630 of the data storage carrier. Additionally, the interface includes multiple communication connectors, e.g., connectors 632 and 634, each of which is adapted to mate with a corresponding communication connector of a disk drive. The interface also includes a communication connector 636 that mates with a corresponding connector 640 of the enclosure.

Of particular interest, the embodiment of data storage system 600 of FIG. 6 is adapted to transfer data using a small computer system interface (SCSI) format. Thus, connector 640 facilitates communication between the carriers and the SCSI format midplane 650. Note that SCSI provides fast data transmission rates; however, such systems are address limited. In particular, data storage systems utilizing 16-bit SCSI typically provide 14 usable addresses for directing data to disk drives.

Assuming, for purpose of example only, that enclosure 610 is a 3U racked enclosure (exhibiting dimensions of 5.25 inches), it is possible to load up to 45 SFF disk drives in the enclosure. However, as noted before, only 14 SCSI addresses are available for connection. By utilizing an embodiment of the multiple disk drive carriers in accordance with the invention, multiple data storage carriers, each of which includes three disk drives, could be used to provide near-optimal data storage density. More specifically, use of data storage carriers configured similar to carriers 616 could enable 42 disk drives to be mounted to such an enclosure.

It should be emphasized that the above-described embodiments of the present invention are merely possible examples of implementations set forth for a clear understanding of the principles of the invention. Many variations and modifications may be made to the above-described embodiments of the invention without departing substantially from the principles of the invention. By way of example, the invention has been described herein with respect to improving performance of legacy data storage systems, e.g., data storage systems that use legacy enclosures. Clearly, embodiments of the invention can be used with and/or incorporate legacy enclosures and/or enclosures that are specifically designed to use data storage carriers, which incorporate multiple disk drives. Additionally, note that data storage systems in accordance with the invention can use various interface types, such as SATA, SCSI, SAS, FC and IB, for example. Clearly, the invention also could be adapted to accommodate later-developed connector types, among others. All such modifications and variations are intended to be included herein within the scope of this disclosure and the present invention and protected by the following claims.

1. A data storage system comprising:
a data storage carrier having:
a housing defining an interior and an opening, the opening being sized and shaped to receive multiple disk drives such that the disk drives are insertable into the interior through the opening; and
an interface mounted to the housing, the interface including multiple second communication connectors and a third communication connector, each of the second communication connectors being accessible via the interior of the housing and being configured to mate with a corresponding one of the first communication connectors such that each of the disk drives communicates with the interface, the third communication connector being accessible via an exterior of the housing, the interface being operative to receive data via the third connector and provide the data to the multiple disk drives via the second connectors.

2. The data storage system of claim 1, further comprising:
multiple disk drives, each of the disk drives having a first communication connector.

3. The data storage system of claim 2, wherein the disk drives are configured to be addressed as a single data storage target such that data is provided to the interface and stored among the disk drives.

4. The data storage system of claim 2, wherein the carrier further comprises:
a controller communicating with the disk drives and the interface, the controller being operative to direct data between the disk drives and the third connector.

5. The data storage system of claim 4, wherein the controller is operative to stripe the data across the disk drives.

6. The data storage system of claim 1, wherein the carrier further comprises:
means for directing data between the disk drives and the third connector.

7. The data storage system of claim 2, wherein the disk drives are 2.5″FF disk drives.

8. The data storage system of claim 2, wherein the carrier further comprises:
a retaining mechanism pivotally attached to the housing and moveable between an open position and a closed position, in the open position the retaining mechanism preventing the first connectors of the disk drives from uncoupling from the second connectors of the interface, in the open position the retaining mechanism providing clearance to enable the disk drives to be removed from the housing.

9. The data storage system of claim 1, wherein the third connector is a hot-swappable connector.

10. The data storage system of claim 2, wherein each of the first connectors is a cold-swappable connector.

11. The data storage system of claim 2, further comprising:
an enclosure defining an enclosure interior and an enclosure opening, the enclosure opening being sized and shaped to receive the housing such that the housing is insertable into the enclosure interior through the enclosure opening, the enclosure having a data bus and a fourth communication connector communicating with the data bus, the fourth communication connector being accessible via the enclosure interior and being configured to mate with the third communication connector such that each of the disk drives communicates with the data bus.

12. The data storage system of claim 11, wherein the enclosure opening is sized to receive a 5.25″FF disk drive; and
wherein the disk drives are three 2.5″FF disk drives.

13. The data storage system of claim 11, wherein the housing is configured to receive the disk drives in a side-by-side relationship with respect to each other.

14. A data storage system for use with a data bus, said data storage system comprising:
a first data storage carrier having multiple disk drives mounted adjacent to each other, the disk drives being addressable via a single data address using the data bus.

15. The data storage system of claim 14, wherein the first data storage carrier further comprises:
a controller communicating with the disk drives and being operative to enable sequential portions of the data received at the single data address of the first data storage carrier to be directed to different ones of the disk drives.

16. The data storage system of claim 14, wherein each of the disk drives are removably mounted to the carrier.

17. The data storage system of claim 14, wherein the first data storage carrier further comprises:
an interface including multiple communication connectors, a first of the communication connectors being configured to enable the interface to communicate with a data bus, remaining ones of the communication connectors being configured to enable each of the disk drives to communicate with the interface.

18. The data storage system of claim 17, wherein the first communication connector is a hot-swappable connector and each of the remaining ones of the communication connectors is a cold-swappable connector.

19. A method for storing data comprising:
providing a carrier; and
mounting multiple disk drives within the carrier.

20. The method of claim 19, wherein mounting multiple disk drives within the carrier comprises:
providing the carrier with a first disk drive of a first form factor; and
enabling the first disk drive to be removed from the carrier and replaced with multiple second disk drives, each of the second disk drives exhibiting a second form factor different than the first form factor.

21. The method of claim 20, wherein, in mounting the multiple second disk drives, the carrier is enabled to exhibit an improved data transfer rate compared to the carrier when using the first disk drive.
